(19) United States
(12) Patent Application Publication
(10) Pub. No.: US 2026/0134749 A1
(43) Pub. Date: May 14, 2026

(54) SUSPENSION OF LIVE VIDEO BASED ON ACTIVE SPORTS WAGER

(71) Applicant: IGT, Las Vegas, NV (US)

(72) Inventors: Dwayne Nelson, Las Vegas, NV (US); Kevin Remus, Las Vegas, NV (US)

(73) Assignee: IGT, Las Vegas, NV (US)

(21) Appl. No.: 18/948,196

(22) Filed: Nov. 14, 2024

(51) Int. Cl. G07F 17/32

(52) U.S. Cl. CPC G07F 17/3225; G07F 17/3211

(57) ABSTRACT

A processor circuit of a system dynamically displays a live video feed for a sporting event and a plurality of wager offers based on current sporting event information for the sporting event, including a first wager offer with first odds. The processor circuit receives a first wager for the first wager offer from a player at a first time and based on receipt of the first wager, stops dynamically displaying the live video feed. The processor circuit records a portion of a live video feed of the sporting event associated with the first wager. The processor circuit determines a first wager result for the first wager based on future sporting event information for the sporting event at a second time after the first time. At a third time after the second time, the first wager result and the recorded portion of the live video feed are displayed.

### BACKGROUND

Embodiments described herein relate to sports wagering for use in a gaming environment, such as in a casino environment, and in particular to suspension of live video based on an active sports wager, and related devices, systems, and methods. Many conventional sports betting devices offer video feeds for various games, which may often be on a time delay, such as when required by game broadcasters and/or content providers. The delay in live video may make it difficult or impossible to place in-game sports wagers on certain outcomes. For example, an outcome of a play during a game may cause an in-game wager to be offered on the next play, with the odds calculated in real time based in part on the outcome of the previous play. By the time the first play is shown in the delayed video, however, the time to wager on the next play may be significantly reduced, and in some scenarios, the next play may already have occurred.

### BRIEF SUMMARY

According to some embodiments, a system includes a processor circuit and a memory coupled to the processor circuit. The memory includes machine-readable instructions that, when executed by the processor circuit, cause the processor circuit to cause the display device to dynamically display a live video feed for a sporting event. The instructions further cause the processor circuit to cause the display device to dynamically display a plurality of wager offers based on current sporting event information for the sporting event, the plurality of wager offers comprising a first wager offer with first odds. The instructions further cause the processor circuit to receive, via the input device, a first wager for the first wager offer from a player at a first time. The instructions further cause the processor circuit to, based on receipt of the first wager, stop dynamically displaying the live video feed. The instructions further cause the processor circuit to record a portion of a live video feed of the sporting event associated with the first wager. The instructions further cause the processor circuit to determine a first wager result for the first wager based on future sporting event information for the sporting event at a second time after the first time. The instructions further cause the processor circuit to cause the display device to display, at a third time after the second time, the first wager result and the recorded portion of the live video feed.

According to some embodiments, a gaming device includes a display device, an input device, a processor circuit, and a memory coupled to the processor circuit. The memory includes machine readable instructions that, when executed by the processor circuit, cause the processor circuit to cause the display device to dynamically display a live video feed for a sporting event. The instructions further cause the processor circuit to cause the display device to dynamically display a plurality of wager offers based on current sporting event information for the sporting event, the plurality of wager offers comprising a first wager offer with first odds. The instructions further cause the processor circuit to receive, via the input device, a first wager for the first wager offer from a player at a first time. The instructions further cause the processor circuit to, based on receipt of the first wager, stop dynamically displaying the live video feed. The instructions further cause the processor circuit to record a portion of a live video feed of the sporting event associated with the first wager. The instructions further cause the processor circuit to determine a first wager result for the first wager based on future sporting event information for the sporting event at a second time after the first time. The instructions further cause the processor circuit to cause the display device to display, at a third time after the second time, the first wager result and the recorded portion of the live video feed.

According to some embodiments, a method includes dynamically displaying, at a display device of a gaming device, a live video feed for a sporting event. The method further includes dynamically displaying, at the display device, a plurality of wager offers based on current sporting event information for the sporting event, the plurality of wager offers comprising a first wager offer with first odds. The method further includes receiving, via an input device of the gaming device, a first wager for the first wager offer from a player at a first time. The method further includes, based on receipt of the first wager, stopping dynamically displaying the live video feed. The method further includes recording, to a memory device, a portion of a live video feed of the sporting event associated with the first wager. The method further includes determining, by a processor circuit, a first wager result for the first wager based on future sporting event information for the sporting event at a second time after the first time. The method further includes displaying, at the display device at a third time after the second time, the first wager result and the recorded portion of the live video feed.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIGS. 3A-3C illustrate a graphical user interface (GUI) for a sports wagering system providing live video, according to some embodiments.

FIG. 4 is a flowchart illustrating operations of systems/methods of suspending display of live sporting event information based on an active wager, according to some embodiments.

FIG. 5 is a flowchart illustrating operations of systems/methods of suspending display of a live video feed based on an active wager and providing recorded video related to the wager result, according to some embodiments.

### DETAILED DESCRIPTION

Embodiments described herein relate to sports wagering for use in a gaming environment, such as in a casino environment, and in particular to suspension of live sporting event information, such as a live video feed, current game statistics, and/or current odds, based on an active sports wager, and related devices, systems, and methods.

Embodiments relate to sports wagering on mobile devices, web browsers, kiosks, and/or any gaming device offering sports wagering. Many conventional solutions provide a delayed video feed for the games, which may be required by game broadcasters and/or content providers. The delay in live video makes it difficult or impossible to place in-game sports wagers on certain outcomes. For example, an outcome of a play during a game may cause an in-game wager to be offered on the next play, with the odds calculated in real time based in part on the outcome of the previous play. By the time the first play is shown in the delayed video, however, the time to wager on the next play may be significantly reduced, and in some scenarios, the next play may already have occurred.

This problem may be exacerbated by the availability of current game statistics and/or game odds, which may be on a shorter delay or no delay. For example, the delayed video feed may be displaying a team in scoring position, but the current game statistics may already display whether the scoring attempt was successful or not. In another example, current odds for an available wager, such as in-game money line bet (i.e., with odds on whether a particular team will win or lose the game), may change in real time based on the actual result of the scoring attempt, before the result is shown in the delayed video feed. These and other problems reduce the availability of in-game wager opportunities and potentially spoil in-game results for players, thereby reducing player enjoyment and engagement.

To address this and other technical problems, embodiments provide unique technical solutions for suspending display of live sporting event information based on betting activity, such as live or delayed video, current game statistics and/or odds, and resuming display of the information after resolution of an active wager. In some examples, portions of the game video can be recorded and packaged for later presentation when the outcome of the active wager is resolved and/or revealed to the player.

Embodiments may be implemented via a number of gaming devices, such as a mobile device, an online website, and/or a dedicated sports betting terminal. Available wagers may be based on game outcomes, such as who will win a game, as well as in-game wagers. These in game wagers may include proposition (i.e., “prop”) bets, such as wagers on the next pitch in baseball, the next down in football, etc. These wagers allow a player to place many wagers per game instead of one wager on the outcome of the game/event, which may increase player enjoyment and engagement.

Many sports wagering mobile applications, websites, and/or sports betting terminals have the capability to show live video, but as discussed above, many current video options (which are typically obtained from third parties) may not have real time or near-real time video options.

For many video providers, the video feed can have some delay, such as a 30 second delay between when something actually happens in the live sporting event and when the video is displayed on the application/terminal display. This delay is a result of various factors including technical limitations such as transmission delays, encoding and decoding delays, etc., and may also be imposed externally by the content providers, e.g., to retain the option to censor inappropriate content and/or to provide more flexibility for advertising breaks. As a result, an operator of the sports application will typically select only in-game wagers that match and/or are relatively unaffected by the delay of the video, excluding certain potential wagers that may be more time-sensitive.

In some embodiments, display of live and/or delayed game information can be suspended while a wager is active, and the operator and/or provider can tie the presentation of the wager outcome with presentation of video associated with the wager outcome at the same time, and in a way that can be saved and played back later. In these and other embodiments, players may also see the outcome of their wagers in a fun manner and at any time they want, e.g., if they are not watching the live event. This makes the delivery of wager wins and losses much more entertaining, and the wager outcome delivery may now have a multimedia aspect that may lead to increased enjoyment and engagement, as well as enabling additional social interactions.

In some examples, a sports wagering system may determine an outcome of a wager and collect one or more videos and/or simulations of the event, referred to herein as a package, for delivery to the player. The package may contain the details of the wager, e.g., amount wagered, amount won, along with one or more multimedia presentations. The player may view the outcome, receive any monetary awards, and can view the multimedia presentations.

In some examples, a player can wager on game events, e.g., individual wagers on various aspects or outcomes of the sporting event, such as an outcome of the game, an outcome during a quarter, etc., and/or in-game wagers, which may be offered dynamically through the game with odds than can also change quickly over time. These wagers offer players the ability to wager many times within one sporting event.

Videos associated with the wager may be created by the sports wagering system. Videos can include snippets or sections of the live video that depicted elements of the wager and/or related video clips. The videos can also include simulations, such as 3D re-creations using traditional display or Virtual Reality, for example.

The system can determine the start and end of the video clips by receiving the information from a sports data provider or by using time limits. For example, in a football game, a team may advance on the first three downs. If a player wagered that the team would run a running play on second down, the system could begin a video clip at the end of first down and end it at the start of third down. Alternatively or in addition, the system could add a constant time such as 10 seconds after first down or 3 seconds before the end of third down. The system could also use Artificial Intelligence (AI) and/or Machine Learning (ML) techniques to determine optimal times for the video to begin and end to show the event in an entertaining way.

In some examples, the system may use multiple video sources, such as different angles of the same event, and/or may combine live video with simulated video. In some examples, one of the video sources may include live commentary such as commentators on a broadcast channel discussing the play.

Each sports wager will produce a win, a loss, or a cancellation (i.e., the event did not happen or was canceled). In some or all of these cases, a package can be created. In one embodiment, the package may contain one or more links to a video, which bay be remotely hosted and/or stored. When the player use the links, the sports wagering system delivers the appropriate video to the device for display. In some examples, the videos may be contained within the package such that the gaming device downloads the entire package and videos onto the device for local streaming and/or playback.

In some embodiments, after the player has placed the wagers and after the wager has been resolved, i.e., the relevant events have occurred, the sports wagering application notifies the player that the package is ready to view. The application might have text, animation, sound, haptics, vibrations, etc. In some examples, outcomes can be shared to social media, text messages, or other communication methods. For example, videos may be shared individually, or the entire package containing wagering details and other information can be shared and experienced by others. In some examples, the system may manage what portions of the package are available for sharing. For example, copyright to the videos may be managed by a third party, where the sports wagering system may not be licensed to share some or all of the video.

In some embodiments, a player may wager on multiple events as part of a single bet, e.g., a parlay bet. The multiple events may be associated with a single game, e.g., a same game parlay, or may be associated with events in multiple different games, which may occur over an extended period of time. In some examples, the results for individual events of the parlay may be hidden until the parlay result is known, e.g., when the parlay bet has been definitively won or lost, or until another time, such as when one more event remains to be resolved, or after a highlight video has been generated. For example, after the parlay events are completed, the system may collect video clips that show the result of each event of the parlay bet. In some examples, the player can choose the order in which to watch each video highlight, or the system can choose the order in which to display based on whether the events contribute to winning the parlay, losing the parlay, or another parameter.

In some examples, social media groups may share wager information and outcome packages among each other. For example, when anyone from the group wagers on an event, all are notified and are encouraged to wager also. When the event is completed, the package is delivered to all members in the group to view, thereby encouraging further social interactions.

In some examples, the system can receive live information, e.g., text descriptions of the current state of the game, and may create a simulated display of the game events. In some examples, AI/ML techniques may be used to create an event video from the information and existing footage of the players and team. In some examples, AI/ML techniques may be used to enhance video of the events, such as displaying punches landed in a boxing match or distance a ball travels during a kickoff.

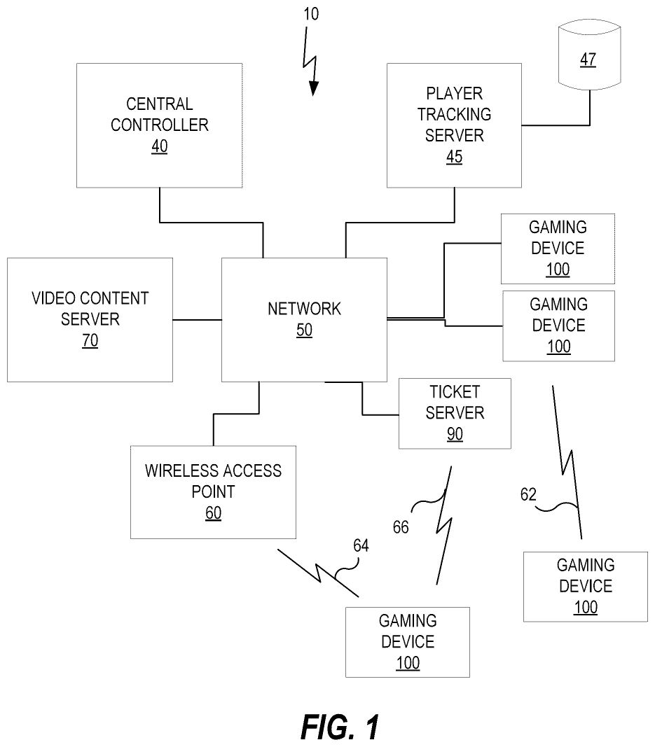

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A video content server 70 may communicate with the central controller 40, player tracking server 45, gaming devices 100, and/or other components of the system 10 to provide video content, such as broadcast, cable, and/or satellite broadcasts, closed circuit video feeds, and/or streaming content, etc., to players at various gaming devices 100. In some examples, the video content server 70 may be a standalone component, or may be incorporated into other components of the system 10, such as the central controller 40, etc.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

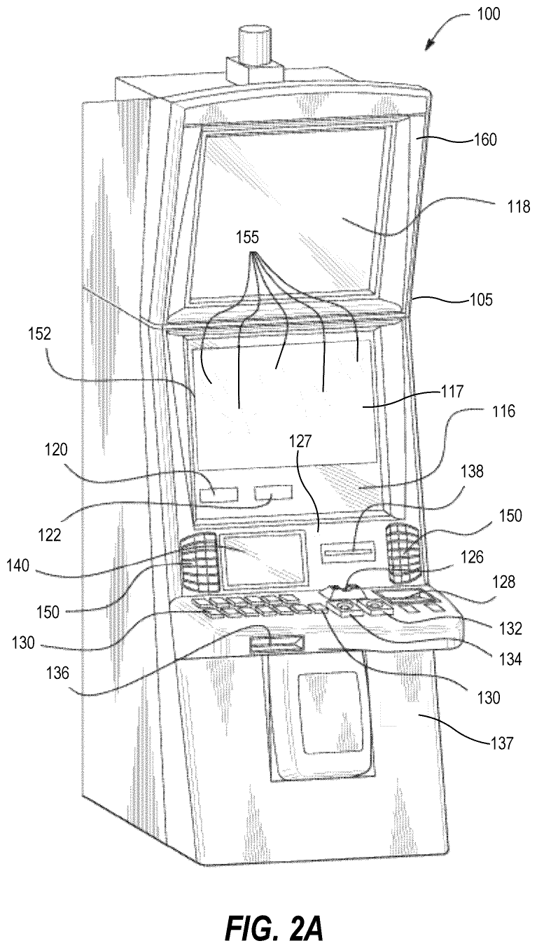

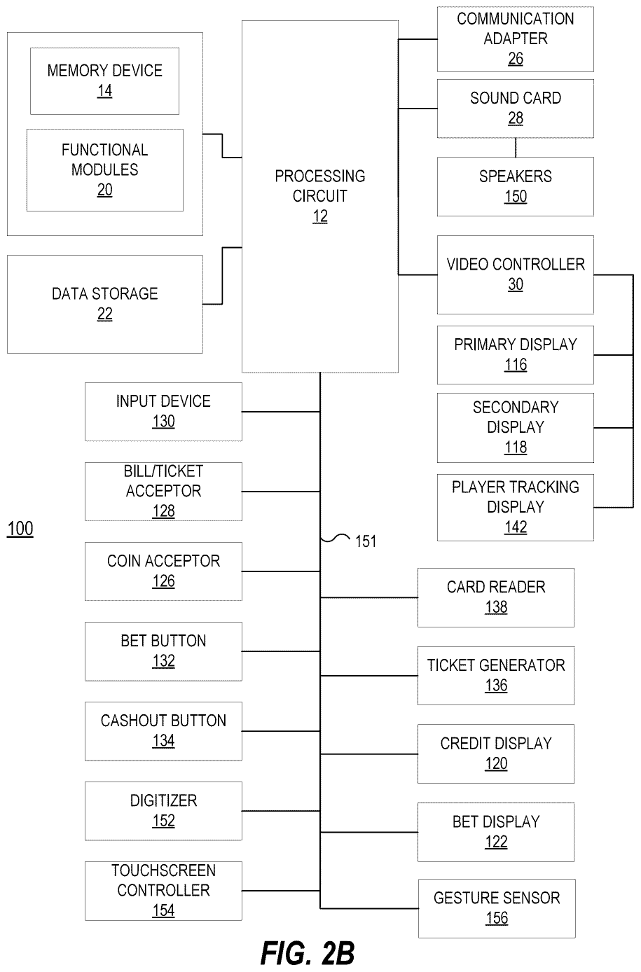

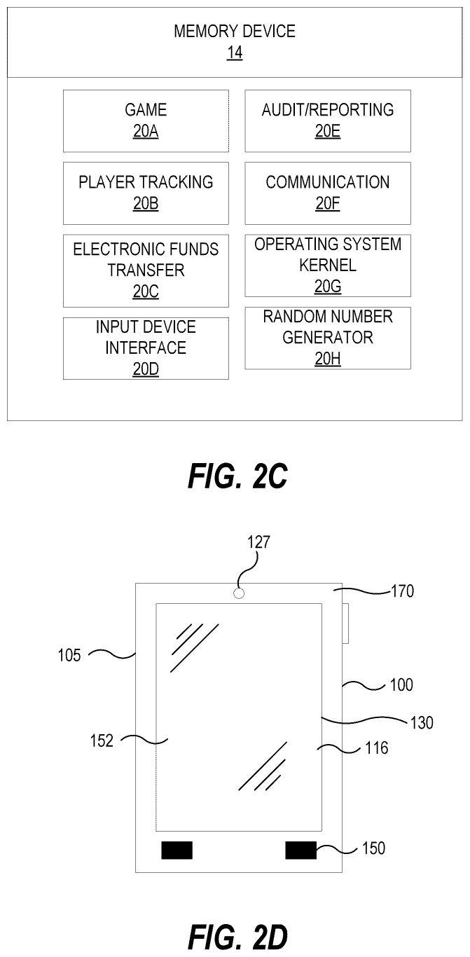

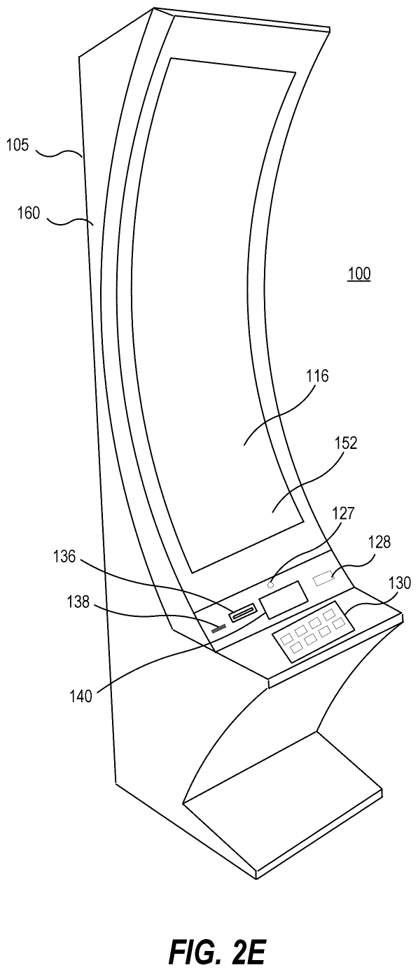

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

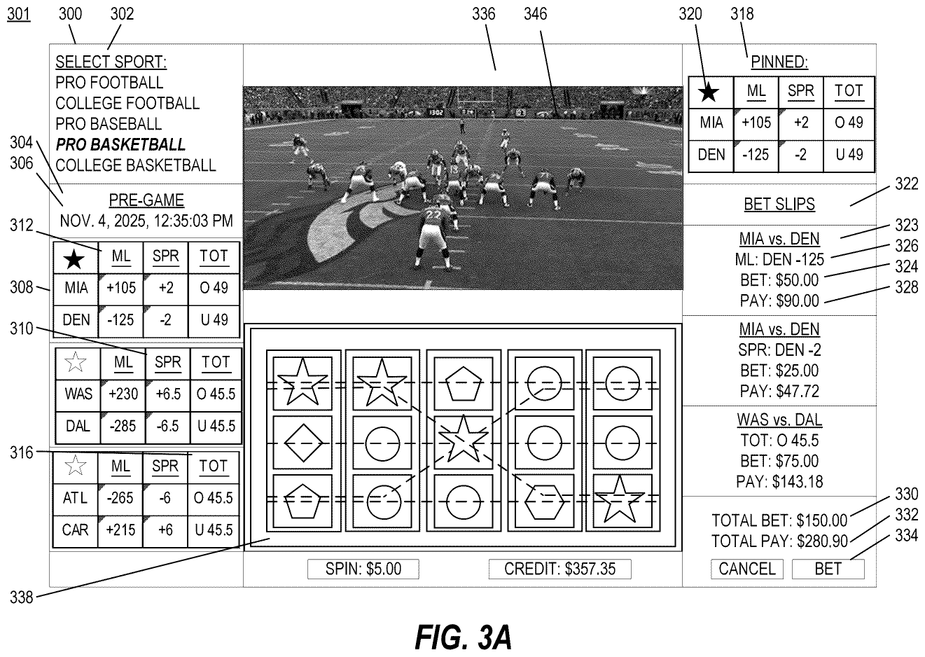

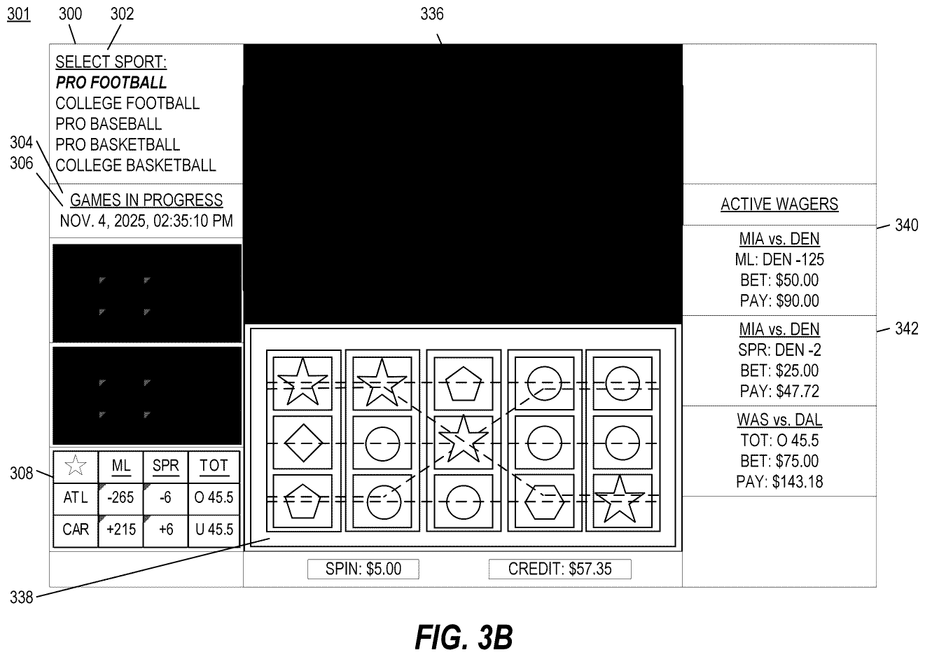

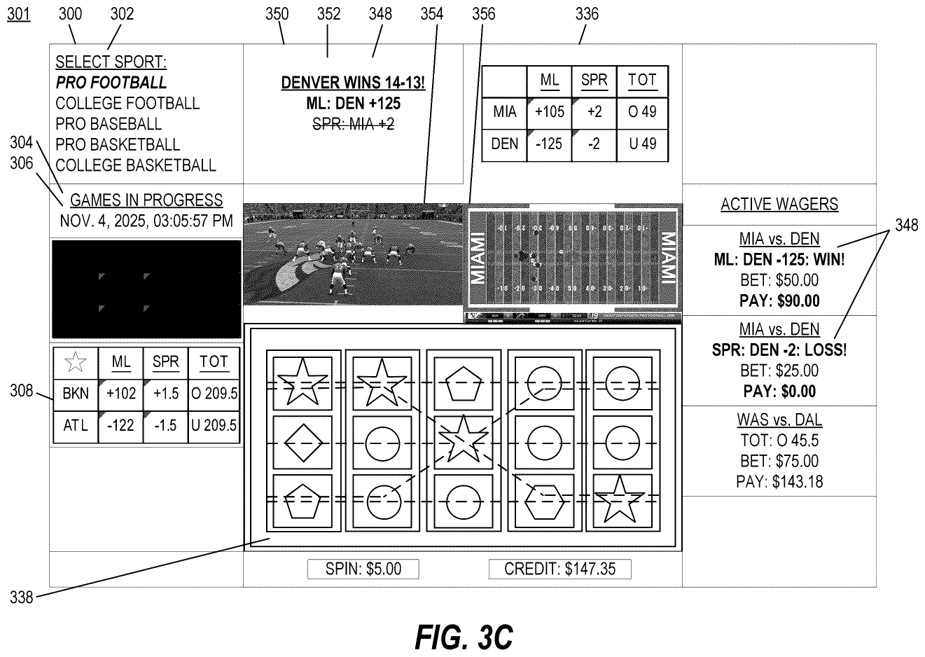

FIGS. 3A-3D illustrate a graphical user interface (GUI) 300 for providing a bonus to a player at a gaming device 301, such as an EGM, sports betting terminal, mobile device, etc., according to some embodiments. As shown by FIG. 3A, the GUI 300 may include a sport selection area 302 with a number of sports and/or categories, e.g., professional baseball, college basketball, professional basketball, boxing, etc. In response to selection of a sport (professional basketball in this example), a game selection area 304 may display a number of games 308 for a particular time period 306 (e.g., a date or date range). The game selection area 304 may also have options to view active wagers for in-progress games and/or available futures bets. Each game 308 may have a number of available wagers 310, such as money line wagers 312, point spread wagers 314, point total wagers 316, etc.

The GUI 300 may also include a pinned bet area 318, such that a player can save certain pinned bets 320 to keep them visible. Pinned bets 320 may include bets where the player has already placed a wager and/or bets that a player desires to otherwise track.

The GUI 300 may further include a bet slip area 322, where a player can construct and place straight bets (i.e., individual standalone bets), parlays, teasers, etc. Each bet slip 323 may have an option for a wager amount 324, along with an indication of associated odds 326 and payout 328 based on the wager amount 324. The bet slip area may include an indication of a total wager amount 330 (e.g., for placing more than one bet at once), an indication of a total payout 332, and a bet button 334 to place the bet(s). In some examples, the GUI 300 may include other gaming elements, such as a slot game 338 that can be played independently at the gaming device 301, as desired.

The GUI 300 may include a video area 336 for displaying video relating to in-progress games, past games, and/or video relevant to the player's active or past bets. Different games 308 in the game selection area 304, pinned bets 320 in the pinned bet area 318, and/or other areas of the GUI 300 may include a video display option 337 to display video relating to the game and/or wager in the video area 336.

In some examples, the gaming device may obtain current sport wagering information from a sports wagering host, which may manage the events, odds, wagers, and/or payments, etc. The gaming device may be also connected to a video distribution system that provides the gaming device with live video, which may be encoded using H.264 over TCP/IP or UDP in some examples, and/or which may employ a hardware-based video mixing device to present and position the images and video on the display.

The gaming device may obtain channel information from the video distribution system and/or a separate video channel information server, as desired, which may provide the gaming device with a TCP/IP and/or UDP address for different channels and/or providers, including available providers, format, etc. For example, the same sporting event may be available from multiple sources with different video quality, production teams, commercial interruptions, etc. In some examples, the gaming device can match a live video feed to a corresponding game and/or set of wagers obtained from the sports wagering host. Video streams may have a number of different parameters, including resolution, frame rate, encoding format, color space (e.g., sRGB), sound encoding/quality, key frame rate frequency, error handling, and/or whether the stream contains simulated video, alternate display (e.g., alternate angles), etc.

In some examples, the system may receive play by play data, such as text descriptions of game activity, from the sports wagering host, and the gaming device may display the information in its original form, and/or as an animation, simulation, graphics, etc. For example, graphics might include logos of the team and/or pictures of element of the game, such as a ball, the field, individual players, etc. In some examples, a 2D or 3D simulation may be generated in real-time and/or near real-time, which may use animations and/or avatars to represent players and/or game elements. In some examples, the display of the information may be generated and/or displayed using AI/ML techniques, as desired. By providing real-time and/or near real-time information, the player may have more up-to-date information than if the player were relying solely on the time-delayed video feed.

Using these and/or other techniques, the GUI 300 can dynamically display current sporting event information for any number of games, such as a text description of the game, e.g., a current score, recent plays, etc., and/or a graphical simulation of the game and/or game activity. In some examples, the dynamic display of the current sporting event information is in real time with respect to the current sporting event information and/or may occurs a predetermined time after the current sporting event information, e.g., on a predetermined delay.

The GUI 300 can also dynamically display a plurality of wager offers, e.g., available wagers 310. The display can be automatic, and/or in response to a request and/or selection by the player in the GUI 300. As shown by FIG. 3B, based on receipt of one or more wagers, e.g., first wager 340, second wager 342, etc., the GUI 300 may stop dynamically displaying the current sporting event information relating to those wagers and may also stop dynamically some or all of the plurality of wager offers, such as those wager offers that are relevant to the active wager. This may occur at the same time as receipt of the wager and/or at a later time, such as in response to a change in the sporting event information, such as a game event that may have an effect on the wager and/or a change in odds for another wager that may be based on similar or related information to the active wager.

In some examples, the GUI 300 may display an indication 344 that the current sporting event information is not available. In this example, the video area 336 may display time-delayed video 346 while the current sporting event information is suspended, so that the player can watch the time delayed video 346 without the risk of viewing information that might reveal game events or results before the time delayed video 346. In some examples, the time-delayed video 346 may displayed before display of the plurality of wager offers, and may be suspended in response to a request to display the wager offers.

After the wagers have been placed and the games occur, wager results are determined for each active wager 340, 342. As shown by FIG. 3C, after the wager result(s) are determined, the GUI 300 displays an indication 348 of the wager result, and may also display a highlight package 350, which may include an indication 352 of the game result, statistics, and other information, video clips 354 relevant to the wager and/or wager result, and/or a simulation 356 of the game events relevant to the wager and/or wager result. For example, the system may record one or more portions of a live video feed of the sporting event associated with the wager, e.g., a portion of the sporting event that resolves the wager, and display the recorded portion of the live video feed as part of the highlight package 350.

In some examples, the display of the indication 348 can be synchronized with the time delayed video 346 so that a portion of the sporting event that resolves the wager is displayed in the time-delayed live video 346 of the sporting event at the same time.

After the results of relevant wager(s) are provided to the player, the GUI 300 may then also resume display of the current sporting event information, including current statistics, current odds for future bets, etc.

In some examples, a player may have the option to enable and/or disable certain features, such as pausing notifications for winning bets, which may allow a player to view bet results all at once as part of a highlight package instead of just seeing the end result of a bet as it occurs. In some examples, settling of wagers and/or updating credit balances may be similarly delayed, to delay the display other potential sources of information about the bet results.

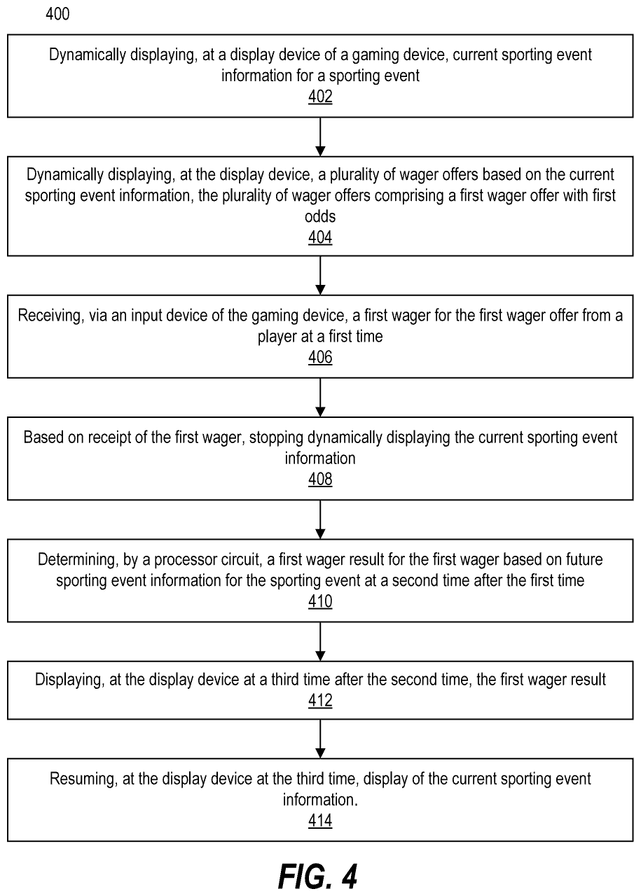

FIG. 4 is a flowchart illustrating operations 400 of systems/methods of suspending display of live sporting event information based on an active wager, according to some embodiments. The operations 400 may be performed by one or more processor circuits of one or more computing devices, such as any of the computing devices described herein, for example. The operations 400 may include dynamically displaying, at a display device of a gaming device, current sporting event information for a sporting event (Block 402). The operations 400 may further include dynamically displaying, at the display device, a plurality of wager offers based on the current sporting event information, the plurality of wager offers comprising a first wager offer with first odds (Block 404). The operations 400 may further include receiving, via an input device of the gaming device, a first wager for the first wager offer from a player at a first time (Block 406). The operations 400 may further include, based on receipt of the first wager, stopping dynamically displaying the current sporting event information (Block 408). The operations 400 may further include determining, by a processor circuit, a first wager result for the first wager based on future sporting event information for the sporting event at a second time after the first time (Block 4010). The operations 400 may further include displaying, at the display device at a third time after the second time, the first wager result (Block 412). The operations 400 may further include resuming, at the display device at the third time, display of the current sporting event information (Block 414).

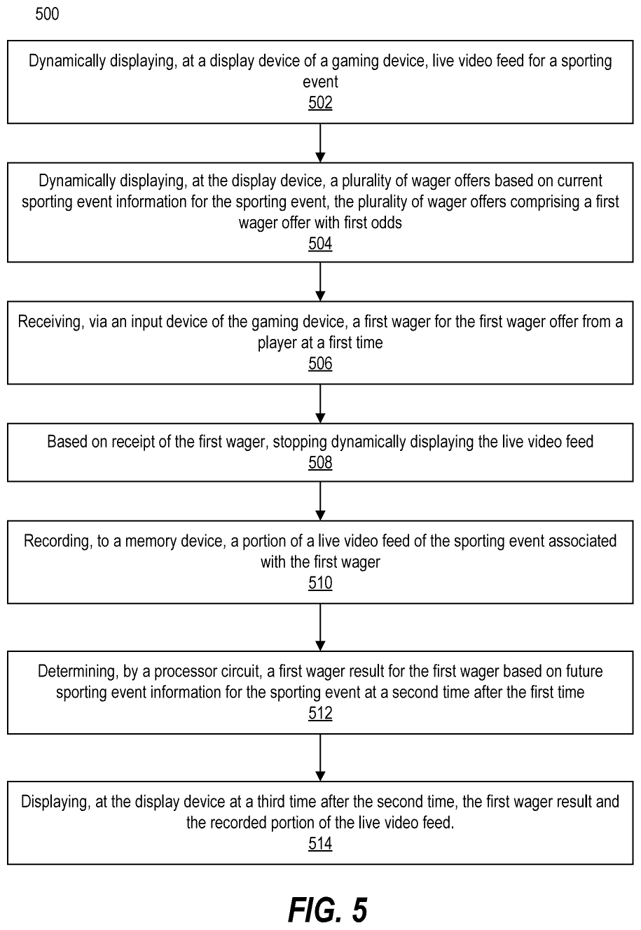

FIG. 5 is a flowchart illustrating operations 500 of systems/methods of suspending display of a live video feed based on an active wager and providing recorded video related to the wager result, according to some embodiments. The operations 500 may be performed by one or more processor circuits of one or more computing devices, such as any of the computing devices described herein, for example. The operations 500 may include dynamically displaying, at a display device of a gaming device, a live video feed for a sporting event (Block 502). The operations 500 may further include dynamically displaying, at the display device, a plurality of wager offers based on current sporting event information for the sporting event, the plurality of wager offers comprising a first wager offer with first odds (Block 514). The operations 500 may further include receiving, via an input device of the gaming device, a first wager for the first wager offer from a player at a first time (Block 506). The operations 500 may further include, based on receipt of the first wager, stopping dynamically displaying the live video feed (Block 508). The operations 500 may further include recording, to a memory device, a portion of a live video feed of the sporting event associated with the first wager (Block 510). The operations 500 may further include determining, by a processor circuit, a first wager result for the first wager based on future sporting event information for the sporting event at a second time after the first time (Block 512). The operations 500 may further include displaying, at the display device at a third time after the second time, the first wager result and the recorded portion of the live video feed (Block 514).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet, or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
dynamically display a live video feed for a sporting event;
dynamically display a plurality of wager offers based on current sporting event information for the sporting event, the plurality of wager offers comprising a first wager offer with first odds;
receive a first wager for the first wager offer from a player at a first time;
based on receipt of the first wager, stop dynamically displaying the live video feed;
record a portion of a live video feed of the sporting event associated with the first wager;
determine a first wager result for the first wager based on future sporting event information for the sporting event at a second time after the first time; and
display, at a third time after the second time, the first wager result and the recorded portion of the live video feed.

2. The system of claim 1, wherein the recorded portion of the live video feed comprises a portion of the sporting event that resolves the first wager.

3. The system of claim 2, wherein the display of the recorded portion of the live video feed comprises a display of the portion of the sporting event that resolves the first wager at the third time.

4. The system of claim 1, wherein the recorded portion of the live video feed comprises a plurality of portions of the sporting event associated with the first wager.

5. The system of claim 1, wherein the instructions further cause the processor circuit to resume, at a fourth time after the second time, display of the live video feed.

6. The system of claim 5, wherein the fourth time is after the display of the recorded portion of the live video feed.

7. The system of claim 1, wherein the dynamic display of the live video feed is in real time with respect to the current sporting event information.

8. The system of claim 1, wherein the dynamic display of the live video feed comprises a predetermined time delay with respect to the current sporting event information.

9. The system of claim 1, wherein the instructions further cause the processor circuit to, based on receipt of the first wager, stop dynamically displaying a subset of the plurality of wager offers.

10. The system of claim 1, wherein the instructions further cause the processor circuit to stop dynamically displaying the live video feed at the first time.

11. The system of claim 1, wherein the instructions further cause the processor circuit to stop dynamically displaying the live video feed at a fourth time between the first time and the second time.

12. The system of claim 11, wherein the instructions further cause the processor circuit to stop dynamically displaying the live video feed at the fourth time further in response to a change in the sporting event information at the fourth time.

13. The system of claim 1, wherein the instructions further cause the processor circuit to:
generate a graphical simulation of the current sporting event information associated with the first wager; and
display, at the third time, the graphical simulation.

14. The system of claim 13, wherein the graphical simulation comprises a video animated simulation.

15. The system of claim 1, wherein the first wager comprises a plurality of wagers on a plurality of wager offers, and
wherein the determination of the first wager result comprises a determination of a plurality of wager results for the plurality of wagers at the second time.

16. The system of claim 1, wherein the instructions further cause the processor circuit to:
receive a request to access the plurality of wager offers, wherein the dynamic display of the current sporting event information and the dynamic display of the plurality of wager offers are initiated in response to receipt of the request.

17. A gaming device comprising:
a display device;
an input device;
a processor circuit; and
a memory coupled to the processor circuit, the memory comprising machine-readable instructions that, when executed by the processor circuit, cause the processor circuit to:
cause the display device to dynamically display a live video feed for a sporting event;
cause the display device to dynamically display a plurality of wager offers based on current sporting event information for the sporting event, the plurality of wager offers comprising a first wager offer with first odds;
receive, via the input device, a first wager for the first wager offer from a player at a first time;
based on receipt of the first wager, stop dynamically displaying the live video feed;
record a portion of a live video feed of the sporting event associated with the first wager;
determine a first wager result for the first wager based on future sporting event information for the sporting event at a second time after the first time; and
cause the display device to display, at a third time after the second time, the first wager result and the recorded portion of the live video feed.

18. The gaming device of claim 17, wherein the recorded portion of the live video feed comprises a portion of the sporting event that resolves the first wager; and
wherein the display of the recorded portion of the live video feed comprises a display of the portion of the sporting event that resolves the first wager at the third time.

19. A method comprising:
dynamically displaying, at a display device of a gaming device, a live video feed for a sporting event;
dynamically displaying, at the display device, a plurality of wager offers based on current sporting event information for the sporting event, the plurality of wager offers comprising a first wager offer with first odds;
receiving, via an input device of the gaming device, a first wager for the first wager offer from a player at a first time;
based on receipt of the first wager, stopping dynamically displaying the live video feed;
recording, to a memory device, a portion of a live video feed of the sporting event associated with the first wager;
determining, by a processor circuit, a first wager result for the first wager based on future sporting event information for the sporting event at a second time after the first time; and
displaying, at the display device at a third time after the second time, the first wager result and the recorded portion of the live video feed.

20. The method of claim 19, wherein the recorded portion of the live video feed comprises a portion of the sporting event that resolves the first wager; and
wherein displaying the recorded portion of the live video feed further comprises displaying the portion of the sporting event that resolves the first wager at the third time.
